(19) United States
(12) Patent Application Publication
(10) Pub. No.: US 2007/0050623 A1
(43) Pub. Date: Mar. 1, 2007

(54) Method of obtaining the user identification for the network application entity

(75) Inventor: Yingxin Huang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/486,643

(22) Filed: Jul. 14, 2006

Related U.S. Application Data
(63) Continuation of application No. PCT/CN05/00065, filed on Jan. 17, 2005.

(30) Foreign Application Priority Data
Jan. 16, 2004 (CN) 200410001029.8

(51) Int. Cl. H04L 9/00

(52) U.S. Cl. 713/168

(57) ABSTRACT

The present disclosure provides a method for Network Application Function to acquire subscriber identity information. According to application of the disclosed method, NAF acquires subscriber identity information so as to facilitate its subscriber management, such as to achieve subscriber charging and/or access control. When NAF serves as an application server proxy, it is able to insert subscriber identity information into the message it forwards, which facilitates the application server that receives the forwarded message to identify the subscriber identity. It is easy and convenient to implement the disclosed method, and the present disclosure is also compatible with the existing associated flows.

### CROSS-REFERENCES TO RELATED APPLICATIONS

This is a continuation of International Application No. PCT/CN2005/000065, which was filed on Jan. 17, 2005, and which, in turn, claimed the benefit of Chinese Patent Application No. 200410001029.8, which was filed on Jan. 16, 2004, the entire disclosures of which are hereby incorporated herein by reference.

### BACKGROUND OF THE DISCLOSURE

1. Field of the Technology

The present disclosure relates to the 3G radio communication technical field, and particularly, to a method for a Network Application Function (NAF) in generic authentication architecture to acquire subscriber identity information.

2. Background of the Invention

In the 3G radio communication standards, generic authentication architecture (GAA) is a general architecture used by the function of plural application services to accomplish verification of subscriber identity. The generic authentication architecture can be used to achieve check of application service subscribers and verification of the subscribers' identity. The above application services can be either multicast/broadcast service, or subscriber certificate service, or instant supply of information service, or proxy service. For instance, in the case of several services in connection with one proxy, the generic authentication architecture can process the proxy as a service as well, and the system architecture can be flexible, and furthermore, new services developed in the future can also use the generic authentication architecture to check the application service subscribers and verify their identity.

FIG. 1 is the schematic diagram illustrating the construction of the generic authentication architecture. The generic authentication architecture generally consists of subscriber 101, Bootstrapping Server Function (BSF) 102 that perform initial check and verification of subscriber identity, Home Subscriber System (HSS) 103 and NAF 104. BSF 102 serves to perform mutual identity check with subscriber 101, and simultaneously generate the key shared by BSF 102 and subscriber 101. HSS 103 stores subscriber description information in a Profile that includes all descriptive information associated with the subscriber including subscriber identity. Additionally, HSS 103 functions to generate authentication information. NAF 104 can be an application server; it can also be an application server proxy. When serving as an application server proxy, it is connected with several application servers like application server 105 and application server 106.

When a subscriber needs a service, the subscriber will go to the BSF directly for mutual authentication if the subscriber knows the service needs mutual authentication process at BSF, otherwise, the subscriber will first contact with a NAF corresponding to the service, and if the NAF uses generic authentication architecture and needs the subscriber to go to the BSF for identity verification, then it informs the subscriber to verify its subscriber identity with generic authentication architecture. Otherwise, it performs other relevant processing.

FIG. 2 is a flowchart for identity verification of the existing techniques using generic authentication architecture.

Step 201, subscriber sends initial authentication request message to BSF;

Step 202, BSF inquires the subscriber's authentication information and Profile from HSS after it receives the subscriber's authentication request;

Step 203, having obtained the response message including the inquired information from HSS, BSF uses the obtained information to mutually authenticate using Authentication and Key Agreement (AKA) with the subscriber. After BSF and the subscriber mutually authenticate using the AKA protocol, they have shared key Ks;

Step 204, BSF allocates a Bootstrapping Transaction Identifier□B-TID□to the subscriber. The B-TID is exclusive to the subscriber and is associated with Ks;

Step 205, having received the B-TID, the subscriber sends a service application request message to NAF, and the request message includes B-TID information;

Step 206, when NAF receives the service application request message including B-TID information sent by the subscriber, it performs local inquiry at NAF first. If the inquiry succeeds, it performs Step 208 directly, otherwise, it sends B-TID inquiry message to BSF and then performs Step 207;

Step 207, having received the inquiry message from NAF, BSF sends a response message of success to NAF if it can find the B-TID needed by NAF, and NAF stores the contents in the message and performs Step 208. Otherwise, BSF sends an inquiry message of response failure to NAF to inform it that the subscriber's information is not available, and NAF informs the subscriber to go to BSF for authentication again and terminates the processing flow;

The response message of success includes the inquired B-TID and shared key Ks associated with the subscriber corresponding to the inquired B-TID, or the derived key generated by shared key Ks according to NAF's security class. Here, NAF and the subscriber also share the shared key Ks or its derived key;

Step 208, NAF communicates with the subscriber, and uses shared key Ks or the derived key generated by Ks to protect the subsequent communications.

When NAF inquires B-TID information from BSF, BSF just returns B-TID and shared key Ks associated with the subscriber corresponding to the B-TID or the derived key generated by shared key Ks if BSF can find the information. But NAF that works as an application server or an application server proxy is not involved in the process to obtain the subscriber's identity information; therefore, it is unable to collect subscriber's charging information and/or control subscriber's access to service layer.

### SUMMARY OF THE INVENTION

The technical solution in accordance with this disclosure is as follows:

the method for Network Application Function to acquire subscriber identity information includes:

storing a Bootstrapping Transaction Identifier (B-TID) with associated subscriber identity information in a Bootstrapping Server Function (BSF) in advance, said BSF is used to perform initial verification of subscriber identity;

when said BSF receives a B-TID inquiry message from said NAF, if the B-TID indicated in said B-TID inquiry message is stored in said BSF, sending the B-TID and the subscriber identity information that said B-TID associated to NAF; and

storing said the B-TID and the subscriber identity information that said B-TID associates in NAF.

With the present disclosure, NAF is able to acquire subscriber identity to facilitate NAF's management of the subscribers, such as to achieve subscriber charging and access control, and reduce network load and optimize network resources with the help of access control. Furthermore, BSF can also decide according to its own policy whether to return the identity information to NAF, which makes the present disclosure's implementing solution more flexible and controllable. When NAF serves as an application server proxy, it is able to insert subscriber identity information into the message it forwards, which facilitates the application server that receives the forwarded message to identify the subscriber identity. It is easy and convenient to implement the present disclosure, and the present disclosure is also compatible with the existing associated flows.

### BRIEF DESCRIPTION OF THE DRAWINGS

FIG. 1 is a schematic diagram illustrating the construction of generic authentication architecture.

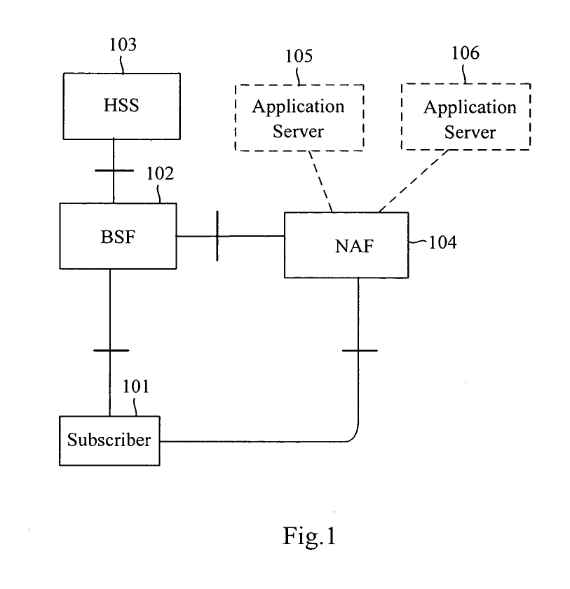

FIG. 2 is a flowchart for subscriber identity verification of the prior art using generic authentication architecture.

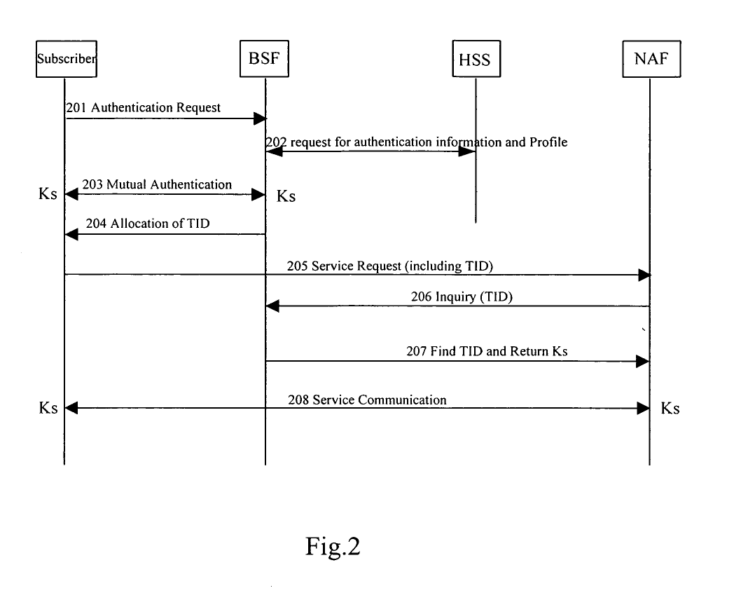

FIG. 3 is a flowchart for subscriber identity verification in accordance with the present disclosure using generic authentication architecture.

### DETAILED DESCRIPTION OF PREFERRED EMBODIMENTS

In order to make the technical solution of the disclosure more explicit, the disclosed method is explained in detail as follows.

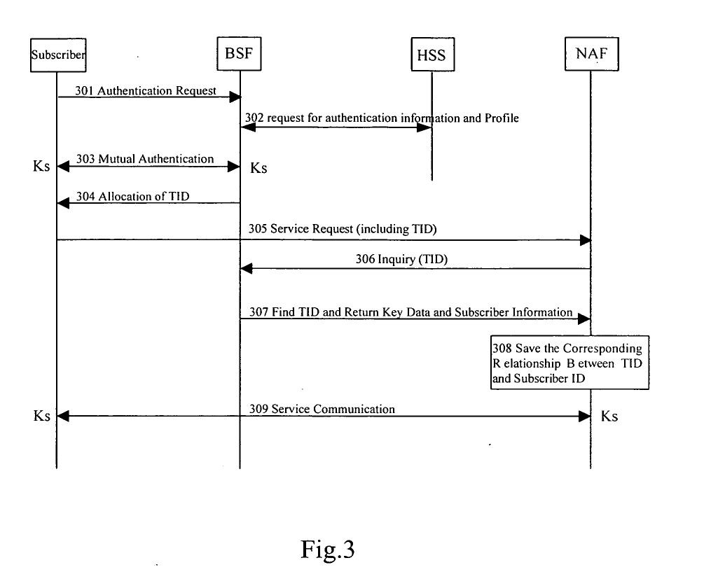

FIG. 3 is a flowchart for subscriber identity verification using the present disclosure's generic authentication architecture.

Step 301, subscriber sends initial authentication request message to BSF;

Step 302, BSF inquires about the subscriber's authentication information and Profile from HSS after it receives the subscriber's authentication request;

Step 303, having obtained the response message including the information from HSS, BSF uses the information to mutually authenticate using AKA with the subscriber. After BSF and the subscriber mutually authenticate using the AKA protocol, i.e., authenticate each other's identity, they have shared key Ks;

Step 304, BSF allocates a B-TID to the subscriber. The B-TID is exclusive to the subscriber and is associated with shared key Ks;

BSF currently stores the B-TID used by the subscriber that has passed authentication and the corresponding relationship between the B-TID used by the subscriber and the subscriber's identity information. The subscriber's identity information is the subscriber's complete Profile, or part of the Profile that is associated with the subscriber's identity information, or only the subscriber's identity.

Step 305, having received the allocated B-TID, the subscriber sends a service application request message to NAF, and the request message carries B-TID information;

Step 306, when NAF receives the service application request message including B-TID information sent by the subscriber, it performs local inquiry at the NAF first, and if the inquiry succeeds, it performs Step 309 directly. Otherwise, it sends B-TID inquiry message to BSF and then performs Step 307;

Step 307, having received the inquiry message from NAF, BSF sends a response message of success to NAF if it can find the B-TID needed by NAF, then performs Step 308. Otherwise, BSF sends an inquiry message of failure to NAF to inform it that the subscriber's information is not available, and NAF informs the subscriber to go to BSF for re-authentication and terminates the processing flow;

The response message of success includes not only the inquired B-TID and the shared key Ks used by the subscriber corresponding to the B-TID, or the derived key generated by the shared key Ks according to NAF's security class, and the subscriber identity information corresponding to the B-TID obtained according to the corresponding relationship said in Step 304. Here, NAF and the subscriber also share the Ks or its derived key;

Step 308, NAF stores the relationship between the subscriber identity information in the above said response message of success and the subscriber's B-TID information;

Step 309, NAF communicates with the subscriber, and protects the subsequent communication with shared key Ks or the derived key generated by Ks, and simultaneously carries out subscriber charging and/or control of access to the service application layer according to the subscriber's identity information.

Thus, NAF acquires the subscriber identity information.

Additionally, in Step 307, BSF also can perform in the following way:

Having found the B-TID needed by NAF in local inquiry, BSF further decides whether it is explicitly indicated in the B-TID inquiry message from NAF that the subscriber identity information is needed; if yes, BSF adds the subscriber identity information needed by NAF into the response message of success. Otherwise, the response message of success returned to NAF does not include the subscriber identity information.

And furthermore, after BSF has decided that it is explicitly indicated in the B-TID inquiry message from NAF that the subscriber identity is needed, the method further includes: BSF decides according to operator policy whether it is permitted to return the subscriber identity information to the NAF; if yes, the response message of success includes the subscriber identity information needed by NAF, otherwise, BSF refuses to add the subscriber identity information in the returned message even if NAF explicitly indicates in the B-TID inquiry message that the subscriber identity and profile information is needed.

If NAF fails to obtain the requested subscriber identity information, NAF can decide according to its own configuration to proceed with the subsequent services or terminate its communication with the subscriber.

When NAF works as an application server proxy to forward a message to other servers, it inserts the subscriber identity into the message that it forwards, so that the receiving application servers are able to identify the subscriber.

Additionally, when the subscriber is to get access to some application server after NAF, NAF can decide if the subscriber has subscribed the service which the subscriber is about to get access to according to the subscriber's profile information stored in it. If the subscriber has not subscribed the service, NAF informs the subscriber directly that the subscriber is not authorized to use the service, therefore it is not necessary to forward the message to the application server behind NAF. In this way, the network resources are optimized.

When the subscriber releases its communication with NAF, NAF continues to store the corresponding relationship between the B-TID used by the subscriber and the subscriber's identity, and the storing time is usually the lifetime of the B-TID, because in the lifetime of the B-TID, the subscriber can continue to use the B-TID to communicate with NAF. When B-TID overtimes, the subscriber's identity is deleted when the B-TID corresponding to the subscriber identity is deleted, or, is forbidden when the B-TID corresponding to the subscriber identity is forbidden.

The above description is only the preferred embodiments of this invention and is not used to limit the protection scope thereof. All the modifications, equivalent replacements or improvements in the scope of the present invention shall be included in the protection scope of the present invention.

1. A method for a Network Application Function (NAF) to acquire a subscriber identity information, comprising:
storing a Bootstrapping Transaction Identifier (B-TID) with associated subscriber identity information in a Bootstrapping Server Function (BSF) in advance, said BSF is used to perform initial verification of subscriber identity;
when said BSF receives a B-TID inquiry message from said NAF, if the B-TID indicated in said B-TID inquiry message is stored in said BSF, sending the B-TID and the subscriber identity information that said B-TID associated to NAF; and
storing said the B-TID and the subscriber identity information that said B-TID associates in NAF.

2. The method according to claim 1, further comprising: presetting the time of storing B-TID with associated subscriber identity information, and when the subscriber disconnects with the NAF, the NAF deleting or forbidding the B-TID and the associated subscriber identity information, if the preset time of storing B-TID with associated subscriber identity information expires.

3. The method according to claim 2, wherein said time of storing B-TID with associated subscriber identity information is B-TID's lifetime.

4. The method according to claim 1, wherein if the B-TID indicated in said B-TID inquiry message is stored in said BSF, further comprising: the BSF continuing to perform the subsequent steps, if said subscriber identity information indicated in said B-TID inquiry message.

5. The method according to claim 4, wherein if said subscriber identity information indicated in said B-TID inquiry message further comprising continuing to perform the subsequent steps after deciding permitting the return of the subscriber identity information to NAF according to operator's policy.

6. The method according to claim 4, if the NAF fails to get the subscriber identity information that it requests, further comprising: the NAF deciding whether to continue communication with the subscriber according to its own configuration.

7. The method according to claim 5, if the NAF fails to get the subscriber identity information that it requests, further comprising: the NAF deciding whether to continue communication with the subscriber according to its own configuration.

8. The method according to claim 1, further comprising: the NAF performing subscriber charging and/or control of the subscriber's access to a service application layer according to the subscriber's identity information.

9. The method according claim 1, wherein said NAF is an application server proxy or an application server.

10. The method according to claim 9, if said NAF is an application server proxy, further comprising: when the NAF forwards a message to other application servers, inserting the subscriber identity information into said message.

11. The method according to claim 1, wherein said subscriber identity information is the complete Profile or part of the Profile related with the subscriber identity, or the subscriber identity.
